(19) United States
(12) Patent Application Publication
(10) Pub. No.: US 2013/0047495 A1
(43) Pub. Date: Feb. 28, 2013

(54) CARBON DIOXIDE BED BUG DETECTION SYSTEM

(71) Applicant: Jonathan Frisch, Brooklyn, NY (US)

(72) Inventor: Jonathan Frisch, Brooklyn, NY (US)

(21) Appl. No.: 13/402,419

(22) Filed: Feb. 22, 2012

Related U.S. Application Data
(60) Provisional application No. 61/445,131, filed on Feb. 22, 2011.

(51) Int. Cl. A01M 1/10; A01M 1/00; A01M 1/14

(52) U.S. Cl. 43/114; 43/123; 43/132.1

(57) ABSTRACT

A bed bug detection system is provided which includes a container having a receiving chamber for holding solidified carbon dioxide, an opening in the chamber communicating with and of sufficient size to insert the solidified carbon dioxide into the receiving chamber, a removable cover fitting over the opening, a plurality of channels formed in walls of the container, the channels allowing flow from the chamber of carbon dioxide to exit outside the walls of the container, exit occurring at exit ports; a plurality of tubes formed of a polymeric material, each tube connected to an exit port; and a plurality of bed bug detector stations, each station attached to one of the plurality of tubes, each of the stations formed of a housing with open first and second ends, and a trapping chemical being deposited within each housing.

### REFERENCE TO RELATED CASES

This application claims priority from Provisional Application Ser. No. 61/445,131, filed Feb. 22, 2011.

### FIELD OF THE INVENTION

The present invention is directed towards a carbon dioxide bed bug detection system.

### BACKGROUND OF THE INVENTION

Fear and shame are two human emotions associated with a bed bug infestation. The emotion of fear is both healthwise and the difficult nature of exterminating the problem. Amongst adverse health effects resulting from bites are possible skin rashes, psychological effects, and allergic symptoms.

The emotion of shame is related to a perceived lack of cleanliness. The problem is manifest in a hotel or other public residency; there can be adverse economic implications resultant from the negative publicity.

Bed bugs are parasitic insects that prefer to feed on human blood. The name of the “bed bug” is derived from the insect's preferred habitat of houses. Most especially they prefer beds or other areas where people sleep. They are mainly active at night, but not exclusively nocturnal. These insects are capable of feeding on their hosts without being noticed.

Although almost eradicated in the 1940s in the developed world, bed bugs have re-emerged in recent years.

Much has been written about the problem and many commercial solutions are available. Not all solutions are fully effective. Not all are economic. Not all are simple and elegant.

Typical of the art is a disclosure entitled “A carbon dioxide, heat and chemical lure trap for the bedbug, Cinex lectularius,” by Anderson et al, Medical and Veterinary Entomology (2009) 23, pp 99-105. Although the trap described therein is effective, expensive chemical lures are necessary and speed of detection is relatively slow.

### SUMMARY OF THE INVENTION

A bed bug detection system is provided which includes:
a container having a receiving chamber for holding solidified carbon dioxide, an opening in the container communicating with and of sufficient size to insert the solidified carbon dioxide into the receiving chamber, a removable cover fitting over the opening, a plurality of channels formed in walls of the container, the channels allowing flow from the chamber of carbon dioxide to exit outside the walls of the container, exit occurring at exit ports;
a plurality of tubes formed of polymeric material, each tube connected to an exit port; and
a plurality of bed bug detector stations, each station attached to one of the plurality of tubes, each of the stations formed of a housing with open first and second ends, and a trapping chemical being deposited within each housing.

The system further includes a lock to sealably hold the cover over the opening in the container. Walls of the container may be constructed of a temperature insulating material examples of which are foamed polyurethane or foamed polystyrene.

The polymeric materials that form the tubes advantageously are formed of an Elastomer. Typical Elastomers are Buna rubber, EPM rubber and latex. Also potentially useful are polymeric materials such as Polyvinyl Chloride, Polypropylene or Polyethylene.

The plurality of channels in the container may range from 2 to 20, preferably from 3 to 10, and optimally from 4 to 6. Advantageously, at least one channel is formed in the cover. More preferably a majority of channels are formed in the cover.

Trapping chemicals preferably are glue or a sticky paste.

A further layer of glue may be deposited on an outside surface of the housing of the detector station. An easily removable release layer (e.g. waxed or silicone treated paper) can cover the further (second) layer of glue. Prior to use, the release layer is stripped away to expose the further layer of glue. The detector station via the further layer of glue can be securely attached to a floor or bedding component to temporarily hold the housing stationary. Advantageously, the holding power (adhesivity) of the glue layer should be greater than that of the further glue layer. Particularly useful is where adhesivity ranges from 10 to 500%, preferably from between 25 to 100% greater for the glue layer relative to the further glue layer.

The system of the first embodiment includes a tray. The container may be supported on a surface of the tray. Advantageously, edges of the tray may be surrounded by upwardly sloping perimeter walls. A surface of at least part of the tray may include a deposit of a glue layer or of a talc layer.

A method for detecting bed bugs is also provided. The method includes:
(1) arranging adjacent a suspected bed bug infested area a detection system which includes:
a container having a receiving chamber for holding solidified carbon dioxide, an opening in the container communicating with and of sufficient size to insert the solidified carbon dioxide into the receiving chamber, a removable cover fitting over the opening, a plurality of channels formed in walls of the container, the channels allowing flow from the chamber of carbon dioxide to exit outside the walls of the container, exit occurring at exit ports;
a plurality of tubes formed of polymeric material, each tube connected to an exit port; and
a plurality of bed bug detector stations, each station attached to one of the plurality of tubes, each of the stations formed of a housing with open first and second ends, and a trapping chemical being deposited within each housing;
(2) charging the receiving chamber with solidified carbon dioxide;
(3) positioning at various locations in the area the plurality of bedbug detector stations;
(4) examining at a subsequent time the detector stations to check for captured bedbugs.

### BRIEF DESCRIPTION OF THE DRAWINGS

Further features and advantages of the present invention may be visualized through consideration of the following drawings in which:

FIG. 1 is a schematic plan view of a carbon dioxide bed bug detection system made according to one embodiment of the present invention;

FIG. 2 is a schematic elevation view, partially in section, of the carbon dioxide bed bug detection system of FIG. 1, and

FIG. 3 is an enlarged fragmentary elevation view of a portion of the bed bug detection system of FIG. 1.

### DESCRIPTION OF THE INVENTION

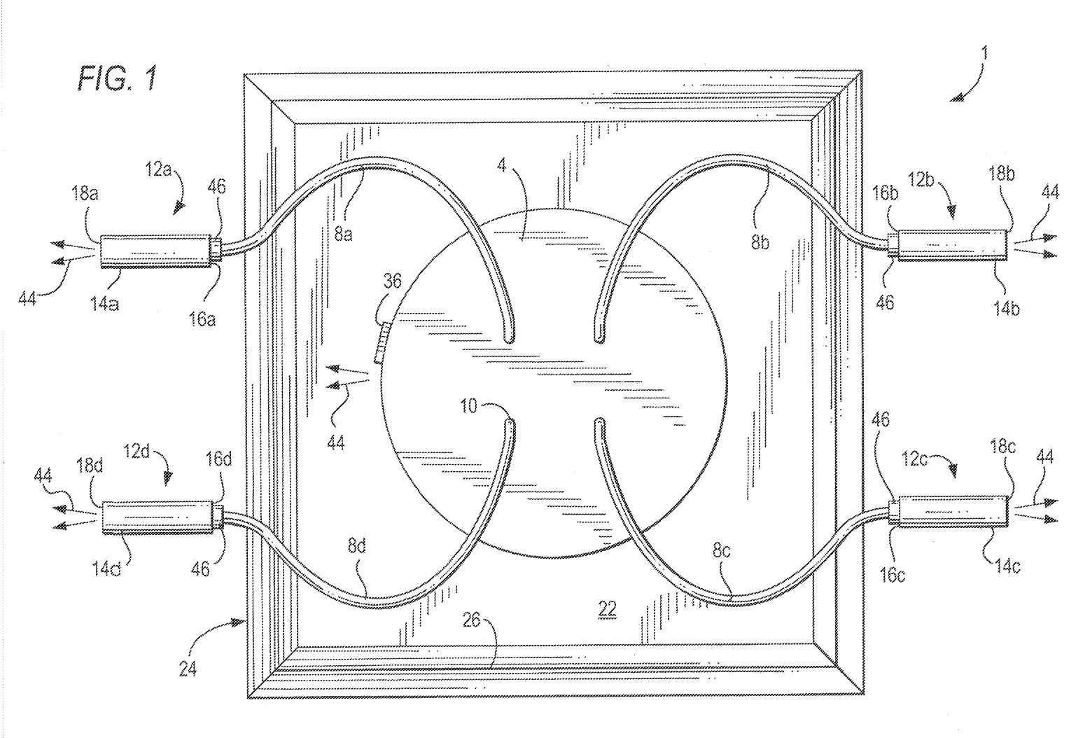

With reference to the drawings, FIGS. 1-3 show a carbon dioxide bed bug detection system, according to the present invention, which includes a lockable insulated carbon dioxide container, a plurality of bed bug detector stations and a plurality of tubes which connect the bed bug detector stations and the carbon dioxide filled container.

During use, a solid block of carbon dioxide, or dry ice, is placed inside a receiving chamber of the container and the top cover is locked in place. The locked cover prevents accidental, unwanted contact with the solid carbon dioxide. The insulated walls of the container prolong the sublimation time of the dry ice and prolong the time during which carbon dioxide vapor flows through the tubes and into the bed bug detector stations.

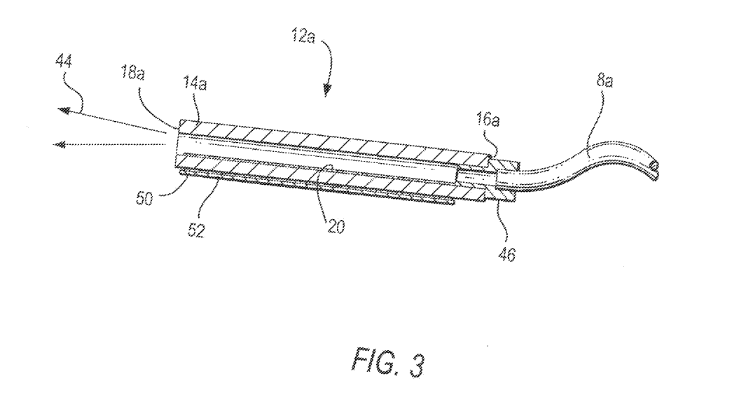

The ends of the tubes each have a fitting, shown typically in FIG. 3 which introduces the carbon dioxide vapor into the space formed by panels of the housing defining bed bug detector stations. The carbon dioxide gas flows through the space between the panels of the bed bug detector stations as indicated schematically by the arrows in FIGS. 1-3. As a result of a known phenomena, bed bugs are attracted to the bed bug detectors by the plumes of carbon dioxide and the bed bugs which are also attracted by the small space formed by the panels, crawl into the spaces. Once inside the space the bed bugs become ensnared by a layer of non-drying glue which is deposited on the panels.

The bed bug detector station also includes a second layer of glue which is protected by a release layer prior to use. The second layer of glue facilitates the installation of the bed bug detectors in various locations.

The present invention through the incorporation of a plurality of tubes and a plurality of bed bug detector stations provides a distributed system of bed bug detector stations which actively attract bed bugs.

The container may advantageously include a rectangular tray with sloping perimeter walls. The walls slope upwardly to allow bed bugs which are attracted by a plume of carbon dioxide discharged through a port formed on the sides of the container, to crawl into the tray. Once the bed bugs are in the tray the bed bugs are ensnared by a layer of glue or a layer of talc or talcum powder which prevents the bed bugs from crawling out of the tray.

FIG. 1 reveals the detection system 2 featuring a container 4 with walls 6 formed of a temperature insulating material such as a foamed Polyurethane or foamed Polystyrene.

A set of four tubes 8a-8d are attached to respective exit ports 10 formed in walls of the container. The tubes may be formed of a polymeric material, particularly an elastomer. Specific examples include different types of rubber such as Buna rubber, EPM rubber and latex. Alternatively, the tubes may be formed of more rigid materials such as Polyvinyl chloride, Polypropylene or Polyethylene.

A series of four bed bug detector stations 12a-12d are connected to respective tubes. Each of the stations are formed of a housing 14a-14d each with an open first and second end 16a-16d and 18a-18d respectively. Within each housing is a trapping chemical 20, particularly a glue or sticky paste.

Container 4 rests on a surface 22 of tray 24. While the container is of circular (cylindrical) shape, tray 24 has a larger two-dimensional area footprint and is either rectangular or square shaped. Along a perimeter of the tray is formed an upwardly sloping perimeter wall 26 with a capital V-shaped cross-section.

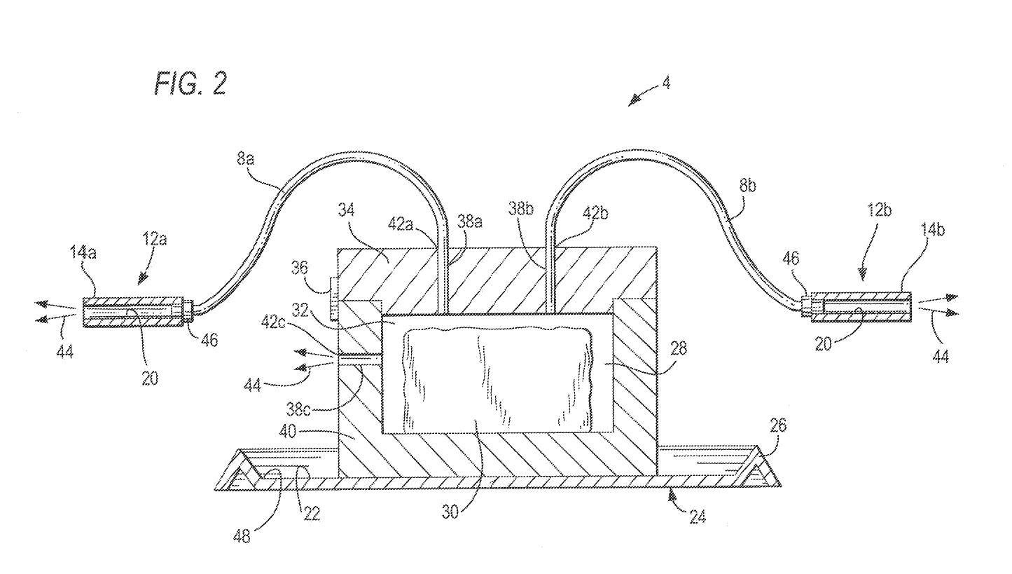

FIG. 2 reveals further features of the container 4. These include a receiving chamber 28 for holding solidified carbon dioxide (also known as dry ice) 30. The receiving chamber is formed with an opening 32. A cover 34 fits over and closes the opening. Lock 36 ensures good seal-ability of the cover to the opening.

A series of channels which in FIG. 2 are referenced as 38a-38c are formed in walls of the container. Channels 38a and 38b traverse cover 34. Channel 38c cuts through a side wall 40. Each of the channels exits their respective walls at respective exits ports 42a-42c. As the solidified carbon dioxide 30 sublimes gaseous carbon dioxide 44 flows through all channels escaping to the outside atmosphere.

The flow of carbon dioxide escaping through the tubes will navigate from the first open end to the second open end of each respective detector station and over the trapping chemical, the latter being a layer of glue.

Each tube is joined to the first end of each detector station by a fitting 46 having at one end a larger circumferential opening and on an opposite second end a smaller circumferential opening.

Tray 24 has a deposit of a glue layer 48 on surface 22.

FIG. 3 illustrates a cross-sectional view of a detector station. A further (second) layer of glue 50 is deposited on an outer surface of housing 14a. As protection prior to use, the further glue layer is covered with a release paper 52. When activated by removal of the release paper, the further glue layer can attach itself to a surface and thereby control any unwanted movement of the detector station.

The present invention may be embodied in other specific forms without departing from the spirit or essential attributes thereof and accordingly, reference should be made to the appended claims rather than to the foregoing specification as indicating the scope of the invention.

What is claimed is:

1. A bed bug detection system comprising:
a container comprising a receiving chamber for holding solidified carbon dioxide, an opening in the container communicating with and of sufficient size to insert the solidified carbon dioxide into the receiving chamber, a removable cover fitting over the opening, a plurality of channels formed in walls of the container, the channels allowing flow from the container of carbon dioxide to exit outside the walls of the container, exit occurring at exit ports;
a plurality of tubes formed of a polymeric material, each tube connected to an exit port;
a plurality of bed bug detector stations, each station attached to one of the plurality of tubes, each of the stations formed of a housing with open first and second ends, and a trapping chemical being deposited within each housing.

2. The system according to claim 1 further comprising a lock to sealably hold the cover over the opening.

3. The system according to claim 1 wherein the walls of the container comprise a temperature insulating material.

4. The system according to claim 3 wherein the temperature insulating material is a foamed polyurethane or a foamed polystyrene.

5. The system according to claim 1 wherein the polymeric material is an elastomer.

6. The system according to claim 1 wherein the polymeric material is selected from the group consisting of Buna rubber, Latex, Polyvinyl Chloride, EPM rubber, Polypropylene and Polyethylene.

7. The system according to claim 1 wherein the plurality of channels ranges from 2 to 20.

8. The system according to claim 1 wherein the plurality of channels ranges from 3 to 10.

9. The system according to claim 1 wherein the plurality of channels ranges from 4 to 6.

10. The system according to claim 1 wherein at least one channel is formed in the cover.

11. The system according to claim 1 wherein a majority of the channels are formed in the cover.

12. The system according to claim 1 wherein the trapping chemical is a glue or paste.

13. The system according to claim 12 wherein a further layer of a glue is deposited on an outside surface of a housing of the detector station.

14. The system according to claim 13 further comprising a removable release layer covering the further layer of glue.

15. The system according to claim 1 further comprising a tray, the container being supported on a surface of a tray.

16. The system according to claim 15 wherein the tray further comprises upwardly sloping perimeter walls.

17. The system according to claim 15 wherein the surface at least in part includes a deposit of a glue layer or of a talc layer.

18. The system according to claim 1 further comprising a plurality of fittings connecting the tubes to their respective detector stations.

19. A method for detecting bed bugs comprising:
(1) arranging adjacent a suspected bed bug infested area a detection system comprising:
a container comprising a receiving chamber for holding solidified carbon dioxide, an opening in the container communicating with and of sufficient size to insert the solidified carbon dioxide into the receiving chamber, a removable cover fitting over the opening, a plurality of channels formed in walls of the container, the channels allowing flow from the container of carbon dioxide to exit outside the wall of the container, exit occurring at exit ports;
a plurality of tubes formed of a polymeric material, each tube connected to an exit port;
a plurality of bed bug detector stations, each station attached to one of the plurality of tubes, each of the stations formed of a housing with open first and second ends, and a trapping chemical being deposited within each housing;
(2) charging the receiving chamber with solidified carbon dioxide;
(3) positioning at various locations in the area the plurality of bed bug detector stations;
(4) examining at a subsequent time the detector stations to check for captured bedbugs.
